(19) United States
(12) Patent Application Publication
(10) Pub. No.: US 2006/0242102 A1
(43) Pub. Date: Oct. 26, 2006

(54) Relaxation-based approach to automatic physical database tuning

(75) Inventors: Nicolas Bruno, Redmond, WA (US); Surajit Chaudhuri, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/111,015

(22) Filed: Apr. 21, 2005

(51) Int. Cl. G06F 17/30

(52) U.S. Cl. 707/1

(57) ABSTRACT

A system that facilitates automatic selection of a physical configuration of a database comprises an optimizer component that determines simulated physical structures and creates a hypothetical configuration based thereon. A reduction component progressively reduces size of the configuration until the hypothetical configuration is associated with a size below a threshold. For example, the simulated physical structures can be based at least in part upon a workload.

### TECHNICAL FIELD

The subject invention relates generally to databases, and in particular to automatic physical database tuning.

### BACKGROUND OF THE INVENTION

Electronic storage mechanisms have enabled accumulation of massive amounts of data. For instance, data that previously required volumes of books for recordation can now be stored electronically without expense of printing paper and with a fraction of physical space needed for storage of paper. In one particular example, deeds and mortgages that were previously recorded in paper volumes can now be stored electronically. Moreover, advances in sensors and other electronic mechanisms now allow massive amounts of data to be collected and stored. For instance, GPS systems can determine location of an individual or entity by way of satellites and GPS receivers, and electronic storage devices connected thereto can then be employed to retain locations associated with such systems. Various other sensors and data collection devices can also be utilized for obtainment and storage of data.

Database systems are often employed for storage and organization of data, wherein such databases can be queried by users to retrieve desirable data. In an exemplary database system, relational databases include redundant structures, such as indexes and materialized views that are employed to correlate rows and columns between disparate tables. The tables and redundant structures are physically created to provide for efficient computation of a given workload (queries and/or updates) while maintaining space constraints. Database systems have been widely deployed and applications associated therewith have become increasingly complex and varied. Conventionally, individuals that designed the database are retained to manage such database and physically alter the database in accordance with a given workload. To reduce expense of staffing a human as a database manager, automatic database tuning systems have been developed to determine a physical configuration of a database given a particular workload, wherein processing and space considerations are balanced.

Complexity of these automatic systems, however, has increased with growth and complexity of database systems. In particular, candidate access paths are heuristically chosen based upon a structure of each input query within a workload, and a “bottom-up” search is performed to identify an optimal physical configuration. In other words, for each query in a workload a set of candidate structures is located, wherein columns that may be useful as index keys and/or sub-expressions have impact upon materialized views are heuristically chosen. Candidate structures are then augmented to improve performance while accounting for space considerations. More specifically, new candidate structures are generated that, while not optimal for a given query, may be beneficial to multiple queries within the workload while reducing space and/or maintaining space in accordance with space constraints. Upon locating one or more valid configurations, the valid configuration (which is empty) is incrementally added or changed until a space constraint is violated. These conventional systems/methods can include various special cases, shortcuts, and heuristics that render such systems difficult to analyze, extract properties, and render it difficult to alter a database system.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The subject invention relates to automatically tuning a database system in accordance with a workload. An optimizer is employed to receive and analyze queries and/or updates within the workload and generate an execution plan based thereon, wherein the execution plan can be a most efficient plan over a space of all possible physical configurations of the database. In more detail, the optimizer receives a query and/or update from within the workload and requests indexes and/or materialized views that are optimal with respect to such query and/or update. These physical structures can then be simulated and provided to the optimizer to create a collection of such physical structures. Given these structures, the optimizer can generate an execution plan, and a resulting configuration can be obtained from such execution plan by noting which physical structures are employed by the execution plan. Thus, rather than the optimizer being given a multitude of possible configurations for a particular workload, the optimizer is provided with best configurations for each query and/or update within the workload.

Upon obtaining a configuration based upon the execution plan generated by the optimizer, size of such configuration can be compared with a threshold size (e.g., size of available memory in a database), and if the size is within the threshold, the configuration can be implemented within a database system. If the configuration is associated with a size above the threshold size, such configuration can be relaxed utilizing a variety of relaxing techniques, thereby reducing size associated with the configuration. For instance, indexes and/or materialized views can be merged within the configuration, thereby reducing size. Furthermore, indexes and/or materialized views can be removed from the configuration to reduce size of such configuration. Accordingly, as size of the configuration is reduced, performance associated therewith can likewise be reduced.

Therefore, a particular relaxation technique to employ can be selected and various cost estimates can be generated. In particular, an estimate of amount of space reduced by a proposed relaxation technique can be created. Further, an estimate of decrease in performance associated with a proposed relaxation technique can be generated and analyzed in connection with the estimate of amount of space reduced. A ratio that is indicative of a quality of a relaxation technique can be created and utilized to select a possible relaxation from a plurality of relaxations. Each time a relaxation technique is undertaken upon the configuration, such configuration can be analyzed to determine if it is associated with a size beneath a threshold. In accordance with one aspect of the subject invention, a configuration can be continuously relaxed, and a configuration chain can be analyzed to locate a relaxation associated with a highest cost. Thereafter, disparate relaxation techniques can be employed at such position. Any suitable system and/or methodology for selecting a manner in which to relax the configuration, however, is contemplated and intended to fall under the scope of the hereto-appended claims.

To the accomplishment of the foregoing and related ends, certain illustrative aspects of the invention are described herein in connection with the following description and the annexed drawings. These aspects are indicative, however, of but a few of the various ways in which the principles of the invention may be employed and the subject invention is intended to include all such aspects and their equivalents. Other advantages and novel features of the invention may become apparent from the following detailed description of the invention when considered in conjunction with the drawings.

### BRIEF DESCRIPTION OF THE DRAWINGS

FIG. 1 is a high-level block diagram of a system that facilitates automatically tuning a database in accordance with an aspect of the subject invention.

FIG. 2 is a block diagram of a system that facilitates generating an optimal execution plan in accordance with an aspect of the subject invention.

FIG. 3 is a block diagram of a system that facilitates implementation of a configuration within a database system in accordance with an aspect of the subject invention.

FIG. 4 is a block diagram of a system that facilitates utilizing one or more relaxing techniques in connection with automatically tuning a database in accordance with an aspect of the subject invention.

FIG. 5 is a block diagram of a system that facilitates estimating parameters relating to a configuration in accordance with an aspect of the subject invention.

FIG. 6 is a representative flow diagram illustrating a methodology for automatically tuning a database in accordance with an aspect of the subject invention.

FIG. 7 is a representative flow diagram illustrating a methodology for generating an execution plan in accordance with an aspect of the subject invention.

FIG. 8 is a representative flow diagram illustrating a methodology for selecting a relaxed configuration in accordance with an aspect of the subject invention.

FIG. 9 is a representative flow diagram illustrating a methodology for selecting a relaxation technique to employ in accordance with an aspect of the subject invention.

FIG. 10 is a schematic block diagram illustrating a suitable operating environment in accordance with an aspect of the subject invention.

FIG. 11 is a schematic block diagram of a sample-computing environment with which the subject invention can interact.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and a computer. By way of illustration, both an application running on a server and the server can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

Furthermore, the subject invention may be implemented as a method, apparatus, or article of manufacture using standard programming and/or engineering techniques to produce software, firmware, hardware, or any combination thereof to control a computer to implement the disclosed invention. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the subject invention.

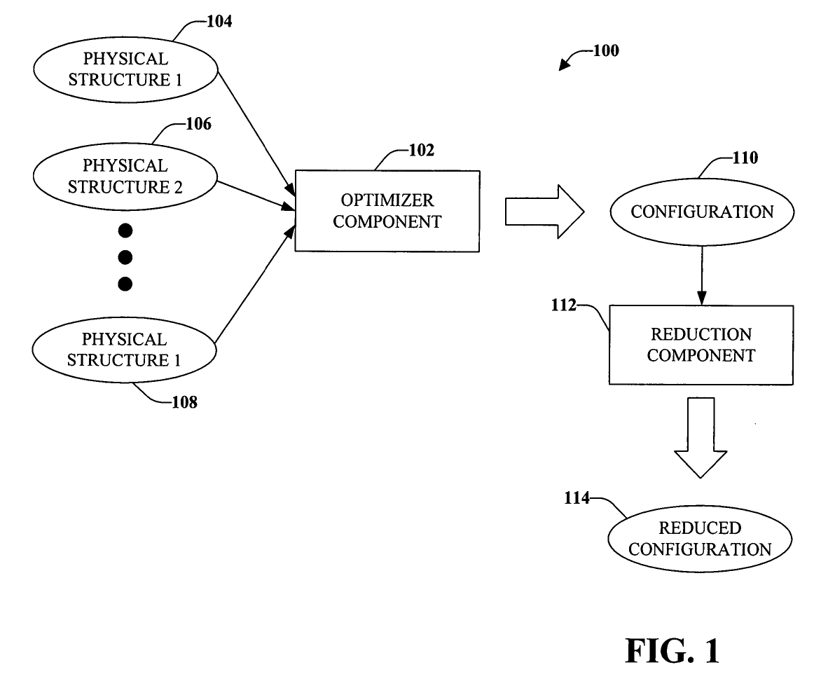

The subject invention will now be described with respect to the drawings, where like numeral represent like elements throughout. Referring now to FIG. 1, a system 100 that facilitates automatic physical tuning of a database system is illustrated. The system 100 includes an optimizer component 102 that is employed to optimize a configuration with respect to a database workload. The database workload includes query and/or update statements that are enacted against a database system. For instance, the database system can be monitored over a period of time, and a workload can be obtained based at least in part upon the monitoring. In other words, the workload includes sets of queries and/or updates that are believed to be subject to repetition. Contents of the workload can change as utilization of the database changes. For example, queries can be monitored and performance of a database system can be analyzed to determine whether physical configuration of the database system should be tuned. In accordance with one aspect of the subject invention, artificial intelligence based systems (e.g., explicitly and/or implicitly trained classifiers) can be employed in connection with performing inference and/or probabilistic determinations and/or statistical-based determinations to determine a workload as well as times that a workload should be altered.

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the subject invention.

The optimizer 102 can optimize a single query and/or update by issuing a plurality of access path requests for indexes and materialized views. For example, an access path generation component associated with the optimizer (not shown) can identify columns in sargable predicates, required sort columns, and columns that are additionally referenced upwards in a query tree. A sargable predicate is a superset of optimizable predicates, which are operators or functions that return a Boolean value. The access path generation component can then analyze available indexes and return one or more alternative physical plans that may be optimal for an input logical sub-query. In general, each generated plan is an instance of a template tree that (i) has one or more index seeks (or index scans) at leaf nodes, (ii) combines leaf nodes by binary intersections or unions, (iii) applies an optional rid lookup to retrieve missing columns, (iv) applies an optional filter operator for non-sargable predicates, and (v) applies an optional sort operator to enforce order. For example, the optimizer 102 can request an index associated with the following sub-query (where τ specifies order):
τ_{D}(Π_{D,E}(σ_{A<10ˆB<10ˆA-C-8}(R)))
Utilizing the above sub-query, the optimizer component 102 can identify column A and B in sargable predicates, column D as a required order, and columns E and C as additional columns that are referenced by non-sargable predicates and/or upwards in the template tree. Given this sub-query, the optimizer component 102 can consider a space of various possible plans for available indexes and return a most efficient physical strategy. For example, multiple plans can be proposed, such as one that reviews all indexes, one that avoids intersecting indexes but performs a greater number of rid lookups, and one that analyzes an index covering columns D, A, B, C, and E, and the optimizer component 102 can select the most efficient of the three.

In accordance with an aspect of the subject invention, an analysis can be undertaken each time the optimizer component 102 issues an index or view request, wherein optimization can be temporarily suspended and the request can be analyzed. For instance, all sargable and non-sargable predicates, order, and additional columns can be considered, as well as SPJG sub-queries in view requests. Such requests are utilized to implicitly encode a plurality of physical structures 104-108 that the optimizer component 102 can exploit. While it is shown that the optimizer component 102 can receive a plurality of physical structures, it is understood that the optimizer component 102 can receive any integer number of physical structures. As size associated with these physical structures would be substantial, it may not be possible to provide the optimizer component 102 with the actual structures. Accordingly, the physical structures 104-108 can be simulated in system catalogs and optimization can resume. Once all suitable physical structures are simulated, the optimizer component 102 can output a configuration 110, wherein the configuration 110 can be an optimal configuration, as the optimizer component 102 is provided with all suitable physical structures regardless of size. Such a procedure can be repeated for each index and/or view request, thereby providing the optimizer component 102 with an optimal set of physical structures to implement logical plans, and the configuration 110 can be based at least in part upon such logical plans. More specifically, the configuration 110 is obtained by way of gathering all simulated physical structures 104-108 that are generated during optimization. Since index requests and view requests are intercepted during optimization, candidates that may not be apparent by viewing a final execution plan are not missed or ignored, as can happen when a “bottom-up” approach is employed.

The optimizer component 102 can utilize an input sub-query as an optimal view, since the input of the view request is the sub-query. Specifically, an optimal plan is a scan over any clustered index over such view. The following example is provided to assist in illustration of one exemplary manner of determining an optimal configuration for an index request. An index request (S, N, O, A) can be considered, where S are columns in sargable predicates, N includes a subset of columns in non-sargable predicates, O are columns in order requests, and A are other referenced columns. If there is no order requested (e.g., O=zero), the following lemma can be employed to restrict space of index sub-plans that can be considered.

Lemma 1: For any plan that intersects rids from two index seeks there is a more efficient plan that produces a substantially similar result by seeking one (larger) index.

If, additionally, |S|1=1 and N=zero, the following lemma can be employed.

Lemma 2: For any plan that employs rid lookups over a result of an index seek, there is a more efficient plan that produces a substantially similar result by seeking one (larger) index.

In instances that both of the above lemmas can be applied, the optimal plan does not include index intersections nor rid lookups, and therefore a covering index with key columns S and suffix columns A are sought. If several sargable predicates are present but N=zero, independence between can be presumed between predicates, thereby enabling an optimal plan to include a seek over a prefix of the columns in S sorted by selectivity, followed by a fetch (which can be optional). An optimal index can be efficiently identified by progressively including new columns from S to the index until no further benefit is obtained. In general, if the index request includes non-sargable predicates (e.g., N≠zero), more complexity is introduced as there can be interaction between columns (e.g., a predicate a+b>10 can be evaluated when an index for other sargable predicates over columns a and b is considered).

In another example, a general case of an index request (S, N, O, A) with O≠zero can be considered. If the configuration 110 produces rows in a desired order, the configuration 110 is an optimal plan. Otherwise, a sort operator at the root of this plan can be utilized to obtain an optimal plan that utilizes the sort. It is possible, however, that a disparate plan exists that does not require sorting and is more efficient. To obtain such a plan, an index with O as its key number can be created. If O⊂S, remaining columns in S can be added to the index as key columns and remaining columns in A can be added to the index as suffix columns. Otherwise, all columns in both A and S can be added as suffix columns. This plan is highly efficient and does not require use of a sort operator. Costs of the two alternatives can be compared, and the plan with minimal expected cost can be returned. The resulting configuration 110 is thus an optimal configuration that cannot be further improved for a defined workload. If space associated with the configuration 110 is less than a maximum allowed and the workload does not include updates, the configuration 110 can be returned without further processing and a database system can be configured according to the configuration 110.

If the configuration 110 is above an allowable size, a reduction component 112 can receive the configuration 110 and undertake selective operations upon such configuration 110 to create a reduced configuration 114 that is associated with an acceptable size. For instance, merge operations, reduction operations, split operations, prefixing operations, and clustering operations can be employed to selectively reduce in size the configuration 110. Once the reduced configuration 114 is an acceptable size, it can be returned to the database system as the physical configuration thereof. In more detail, the reduction component 112 receives the configuration 110 (which can be optimal) that is too large to fit into available space, and then progressively transforms the configuration 110 into new configurations that consume less space (but are less efficient) than previous configurations. Such an approach is more efficient than when compared with conventional “bottom-up” approaches. In more detail the configuration C={c₁, . . . , cₙ} can be considered and relaxed into C′ by way of replacing c₁ and c₂ by c₃ (e.g., an index on (a, b) and an index on (a, d) by an index on (a, b, d)). As C′ is composed of less efficient structures than C, it can be determined that a query that does not utilize indexes c₁ or c₂ in configuration C can remain unchanged in C′. Thus, only queries that employ some of the relaxed structures in C should be subject to re-optimization. In contrast, in a “bottom-up” strategy, adding a new index to an existing configuration requires re-optimization of all queries that reference the index table.

Various estimating and searching algorithms can be employed by the reduction component 112 to progressively reduce size of the configuration 110, thereby creating the reduced configuration 114. For example, for each proposed modification, a ratio of benefits in space against losses in computation time can be computed, and such ratio can be employed to selectively choose operations to be undertaken on the configuration 110. This ratio can be calculated with respect to index transformations, view transformations, and updates (e.g., removals, additions, and/or alterations). In another example, locating each configuration can include selecting a configuration and thereafter comparing benefits (estimated or otherwise) of the configuration against previously obtained configurations. A configuration that is perceived to perform better is retained, and disparate configurations are undertaken and performances associated therewith are estimated until a time constraint is violated. A best configuration at that time (e.g., the reduced configuration 114) is then provided to a database system.

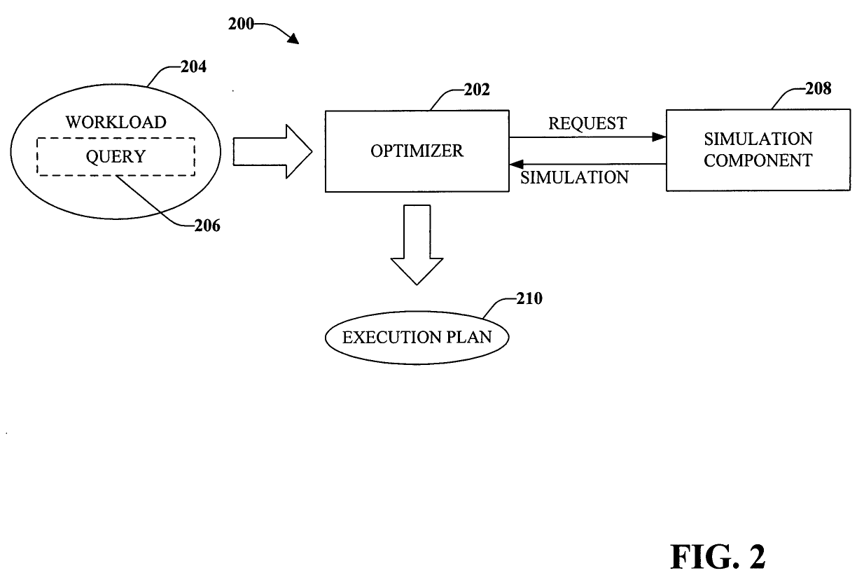

Now turning to FIG. 2, a system 200 that facilitates generating of an execution plan that can be utilized in connection with automatically tuning physical configuration of a database is illustrated. The system 200 includes an optimizer 202 that receives a workload 204, wherein the workload 204 includes at least one query 206. The query 206 can be broken into a plurality of sub-queries by the optimizer 202 to enable such optimizer 202 to determine a physical configuration that is optimal for retrieving data based upon the query 206. For instance, upon receipt of the query 206, the optimizer 202 (if desirable) can break the query 206 into one or more sub-queries and request a physical structure that can be employed to optimize the query 206. The request is received by a simulation component 208 that provides the optimizer 202 with a simulation of the requested physical structures. Thus, any structure that the optimizer 202 requests is provided to such optimizer 202. The optimizer 202 can then generate an execution plan 210 that is optimal with respect to the each query within the workload 204. Again, the execution plan 210 is optimal as nothing is held from the optimizer 202. Physical structures employed by the execution plan 210 can then be collected and utilized as an optimal configuration with respect to the workload 204. In more detail, each execution plan associated with the queries in the workload can be analyzed, and physical structures utilized therein can be unified to generate an optimal physical configuration with respect to the workload 204.

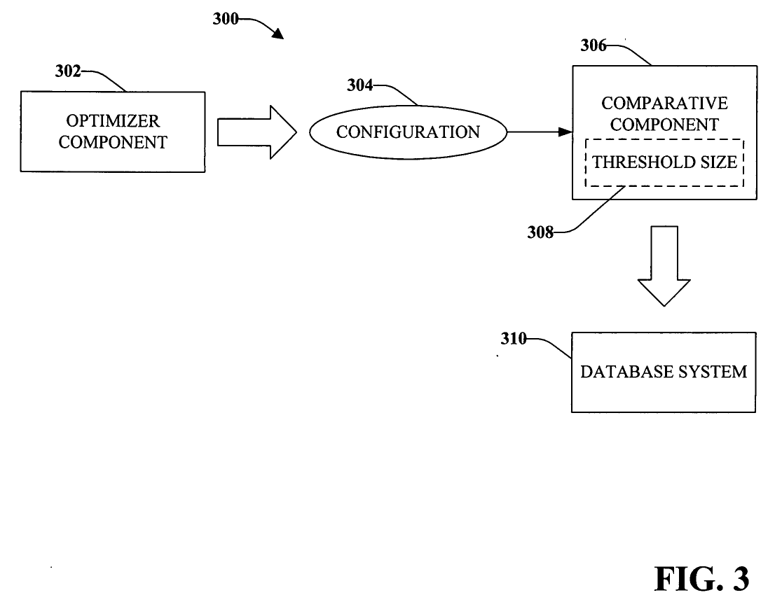

Turning now to FIG. 3, an exemplary system 300 that can be employed to physically configure a database system is illustrated. The system 300 includes an optimizer component 302 that can be utilized to determine an optimal configuration 304 with respect to a given workload. The workload can include various queries and/or update commands, such as delete, add, and/or modify commands. The configuration 304 can then be received by a comparative component 306 that compares size of the configuration 304 with a threshold size 308. For instance, the threshold size 308 can be an amount of size in memory of a database system 310 in which the configuration 304 is desirably implemented. If the size of the configuration 304 is beneath the threshold size 308, such configuration 304 can be implemented within the database system 310. If size of the configuration 304 is above the threshold size 308, the configuration can be progressively reduced in size through one or more operations and by way of various heuristics. Once the configuration 304 is reduced to a size below the threshold size 308 while maintaining adequate performance, the configuration 304 can be implemented within the database system 310.

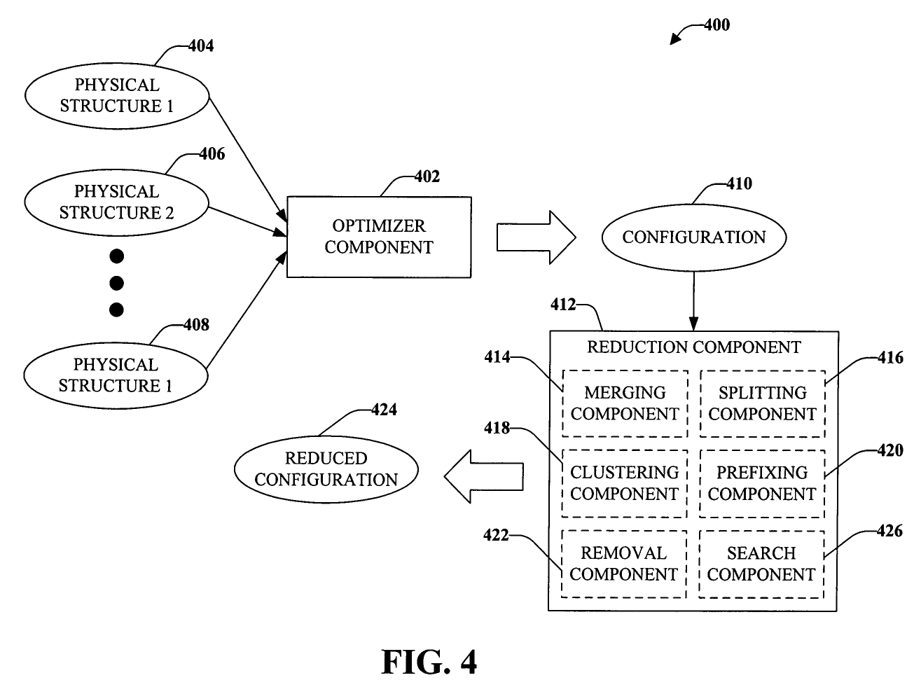

Turning now to FIG. 4, a system 400 that facilitates automatic tuning of a database system is illustrated. The system 400 includes an optimizer component 402 that receives a query or sub-query (not shown), and locates one or more indexes that can solve at least sub-portions of the received query. In accordance with one aspect of the subject invention, the optimizer component 402 can locate a best possible index associated with the sub-query, regardless of size of the index. Simulations of physical structures 404-408 can then be provided to the optimizer component 402, wherein such physical structures 404-408 represent a collection of indexes and materialized views that were requested by the optimizer component 402 to satisfy portions of queries within a workload. These physical structures 404-408 can then be received by the optimizer component 402 to create an execution plan. A configuration 410 can then be determined by collecting physical structures from the physical structures 404-408 that are employed within the execution plan.

Typically, as the optimizer component 402 is provided with indexes and materialized views that are optimal for each query within a workload, a resulting configuration 410 will be of substantial size (e.g., too large to implement within a database system). A reduction component 412 can be utilized to reduce size of the configuration 410 by way of merging, splitting, reducing, clustering, and prefixing operations. In more detail, the reduction component 412 can include a merging component 414 that is utilized to merge indexes as well as merge views, a splitting component 416 that can rearrange overlapping columns of indexes, a clustering component 418 that can promote an index to a clustered index, a prefixing component 420 that can be employed to prefix indexes, and a removal component 422 that can be utilized to remove indexes from the configuration 410.

With more specificity in regards to the reduction component 412 and components associated therewith, an index I can be associated with a sequence of key columns K and a set of suffix columns S, so that I=(K:S). Further, it can be delineated that if S₁ and S₂ are sequences S₁∩S₂ (and similarly S₁=S₂) can return a sequence that includes elements in an intersection (similarity, differences) of S₁ and S₂ in a substantially similar order as they appear in S₁. Now referring to the merging component 414, merging of indexes I₁=(K₁:S₁) and I₂=(K₂:S₂) can be defined as an index that can answer all requests that either I₁ and I₂ can individually answer and that can be efficiently sought in cases that I₁ can be sought. It is possible, however, that some requests that can be answered by seeking I₂ may need to scan the merged index. In still more detail, the merging of indexes I₁ and I₂ can be defined as I_{1,2}=(K₁:(S₁∪K₂∪S₂)−K₁). If K₁ is a prefix of K₂, I_{1,2} can be defined as (K₂:(S₁∪S₂)−K₂). For instance, merging I₁=([a,b,c]:{d,e,f}) and I₂=([c,d,g]:{e}) results in I_{1,2}=([a,b,c]:{d,e,f,g}). Accordingly, if the configuration 410 (C) is relaxed by way of merging I₁ and I₂, a reduced configuration 424 (C′) will result and be of the form C′=C−{I₁,I₂}∪{I_{1,2}}.

As stated above, the reduction component 412 can further include a splitting component 416 that is employed to introduce index intersection plans by way of rearranging overlapping columns of existing (wider) indexes. For instance, if indexes I₁=(K₁:S₁) and I₂=(K₂:S₂) exist, splitting such indexes can produce a common index I_{C} and possibly residual indexes I_{R1} and I_{R2}. In practice, usages of index I₁ (respectively, I₂) by a less efficient index intersection between I_{C} and I_{R1} (respectively, I_{R2}), or rid lookups over I_{C}'s result if I_{R1} (respectively, I_{R2}) does not exist. In particular, I_{C} can be defined as being equal to (K_{C}−K₁∩K₂:S_{C}−S₁∩S₂) so long as K_{C} is non-empty (index splits can remain undefined if K₁ and K₂ have no common columns). In turn, if K₁ and K_{C} are different, I_{R1}=(K₁−K_{C},I₁−I_{C}), and if K₂ and K_{C} are different I_{R2}=(K₂−K_{C},I₂−I_{C}). As an example, I₁ can be defined as I₁=([a,b,c]:{d,e,f}), I₂ can be defined as I₂=([c,a]:{e}), and I₃ can be defined as I₃=([a,b]:{d,g}). Splitting I₁ and I₂ results in I_{C}=([a,c]:{e}), I_{R1}=([b]:{d,f}) and I_{R2}=([d]). Splitting I₁ and I₃ results in I_{C}=([a,b]:{d}) and I_{R1}=([c]:{e,f}). If the configuration 410 (C) is relaxed by splitting I₁ and I₂, the reduced configuration 424 (C′) can be defined as C′=C−{I₁,I₂}∪{I_{C},I_{R1},I_{R2}}.

The clustering component 418 can also be employed to analyze the configuration 410 and make alterations to reduce such configuration 410 in size, thereby generating the reduced configuration 424. For instance, the clustering component 418 can promote an index I over a table T within the configuration 424 to a clustered index, so long as the configuration 410 does not include another clustered index over table T.

The prefixing component 420 can also be utilized to reduce size of the configuration component 410 to create the reduced configuration 424. For instance, index I can be defined so that I=(K:S). If a prefix K′ of K is taken (including K′=K if S is not empty), an index I_{P}=(K′,0) can be obtained that can answer arbitrary requests that I answers by optionally performing rid lookups to obtain remaining columns (K−K′)∪S. If the configuration 410 (C) is relaxed by prefixing index I with I_{P}, the reduced configuration 424 (C′) results so that C′=C−{I}∪{I_{P}}. Moreover, the removal component 422 can be employed to remove an index I from the configuration 410 (C), leaving the reduced configuration 424, which can be defined as C′=C−{I}. The reduction component 412 can thus utilize various mechanisms and techniques to progressively reduce the configuration 410 until the resultant reduced configuration 424 lies within a size constraint.

The reduction component 412 can further be employed in connection with transforming views associated with the configuration 410, thereby reducing size of such configuration 410. For example, a view V can be denoted as a 6-tuple view so that V=(S, F, J, R, O, G), where S is a set of base-table or aggregate columns, F is a set of tables, J is a set of equi-join predicates, R is a set of range predicates, O is a conjunction of predicates not in J or R, and G is a set of base-table columns. Furthermore, it is understood that all aforementioned components can be empty except for S and F. For instance, an SQL equivalent for V can be written as follows:

SELECT S

FROM F

WHERE J AND R AND O

GROUP BY G

To further illustrate reduction of views, an SPJG query Q can be considered, where Q is desirably matched with view V=(S_{V}, F_{V}, J_{V}, R_{V}, O_{V}, G_{V}). Q can be rewritten as a 6-tuple query Q=(S_{Q}, F_{Q}, J_{Q}, R_{Q}, O_{Q}, G_{Q}), and a subsumption test can be applied to each pair of components. If all subsumption tests are successful, Q can be rewritten using V. Subsumption tests can vary among systems, wherein completeness and efficiency are balanced. In one example, for Q and V to match, F_{Q} should be equal to F_{V}, as V would have already matched a sub-query of Q during optimization if F_{V}⊂=F_{Q}. Further, O_{V}'s conjunctions should be included in O_{Q}'s conjunctions. Remaining components can be checked by way of using simple inclusions tests.

In accordance with an aspect of the subject invention, the merging component 414 can be employed to merge views and thus reduce size of the configuration 410. Similar to merging indexes, merging views V₁ and V₂ can result in a view V_{M} from which all information within V₁ and V₂ can be extracted. More specifically, V_{M} can be matched during instances that V₁ and V₂ are matched. To assist in defining view merges, V₁ and V₂ can be defined so that V₁=(S₁, F₁, J₁, R₁, O₁, G₁) and V₂=(S₂, F₂, J₂, R₂, O₂, G₂). Furthermore, as a condition for merging, F₁ can be required to be equal to F₂. Merging of V₁ and V₂ can be defined as

V_{M}=(S_{M}, F_{M}, J_{M}, R_{M}, O_{M}, G_{M}), where F_{M}=F₁=F₂, J_{M}=J₁∩J₂, R_{M}=R₁ “merge” R₂ (e.g., R_{M} combines same-column range predicates in R₁ and R₂), O_{M}=O₁∩O₂ (where the intersection uses structural equality), G_{M}=G₁∪G₂ if both G₁ and G₂ are non-empty (if either is empty, G_{M}=0), and S_{M}=S₁∪S₂ if G_{M}≠0. If G_{M}=0, then S_{M}=S₁∪S₂−S_{A}∪S_{A}′, where SA is a set of aggregated columns in either S₁ or S₂ and S_{A}′ is a set of base-table columns in S_{A}. Moreover, if a range predicate in R_{M} becomes unbounded (e.g., after merging R.a<10 and R.a>5), the range predicate can be eliminated from R_{M}. If, however, G_{M}≠0, a corresponding column can be added to G_{M} and S_{M} so that range predicates can be evaluated with V_{M}. To illustrate merging undertaken by the merging component 414, the following example is provided.

```
V₁ =
SELECT R.a, R.b
FROM R,S
WHERE R.x = S.y
    AND 10 ≦ R.a ≦ 20
    AND R.b*R.b < 10
V₂ =
SELECT R.a, sum(R.c)
FROM R,S
WHERE R.x = S.y AND R.w = S.z
    AND 15 ≦ R.a ≦ 25
    AND 10 ≦ R.b
GROUP BY R.a
Merging V₁ and V₂ can result in a following view:
V_{M} =
SELECT R.a, R.b, R.c
FROM R,S
Where R.x = S.y
    AND 10 ≦ R.a ≦ 25
    AND 10 ≦ R.b
```

After views V₁ and V₂ are merged into V_{M}, indexes over V₁ and V₂ can be promoted to V_{M}. In other words, for each index I(K:S) over V₁ (respectively, V₂) an index I_{M}(K′:S′) can be created, where K′ and S′ include columns in K and S mapped from V₁ (respectively, V₂) to V_{M}. If the configuration 410 (C) is relaxed by merging V₁ and V₂ into V_{M}, the reduced configuration (C′) can be created, where C′=C−{V₁,V₂}−I_{V}_{₁}−I_{V}_{₂}∪{V_{M}}∪I_{V}_{_{M}}, where I_{V}_{₁}, I_{V}_{₂}, and I_{V}_{_{M}} are indexes associated with V₁, V₂, and V_{M}, respectively.

Along with merging, the reduction component 412 can employ the removal component 422 to aid in reduction of size of the configuration 410 to create the reduced configuration 424. For instance, any view V in the configuration 410 (C) can be removed to create the reduced configuration 424 (C′), so that C′=C−{V, I₁, . . . , Iₙ}, where I₁, . . . , Iₙ are indexes defined over V.

As the reduction component 412 can utilize various components to reduce size of the configuration 410, it is important that appropriate reductions are taken. For instance, while resulting in a substantially similar size, performing a merge operation on the configuration 410 can result in a much less optimal configuration as compared to performing a split operation on the configuration 410. Accordingly, the reduction component 412 can include a search component 426 that estimates value of performing disparate actions upon the configuration 410. This estimation essentially determines a benefit in space versus a loss in execution time, and can be employed in connection with selecting operations to perform on the configuration 410.

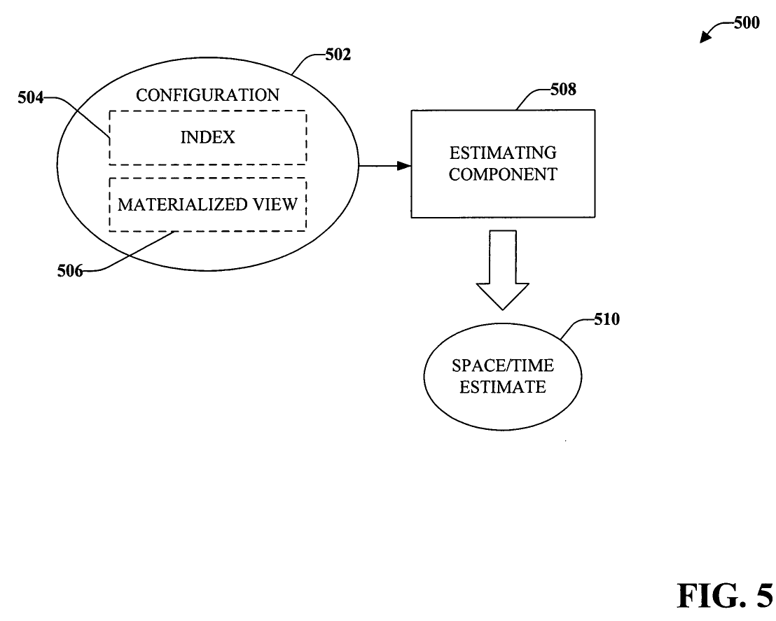

Now turning to FIG. 5, a system 500 that facilitates analyzing proposed alterations to be undertaken upon an optimal configuration is illustrated, wherein the alterations are utilized to reduce size of the configuration so that it meets a threshold. The system 500 includes a configuration 502 that is desirably reduced in size, wherein the configuration 502 includes one or more of an index 504 and a materialized view 506. An estimating component 508 receives the configuration 502 and generates estimates relating to space resulting from an operation and/or execution time associated with the configuration 502 after alteration thereof (e.g., reduction in size).

As stated above, the estimating component 508 can estimate an amount of space consumed by the configuration 502. In one example, an index I can be defined over a table T, such that I=(K:S) over such table. To estimate size of the index I, width of an entry in any of I's leaf nodes can be calculated as W_{L}=Σ_{cεK∪S} width(c), where width(c) is a system-dependent constant if c is a fixed-length column (e.g., integers are four bytes long), or is an average length of values of c in a database if c is a variable-length column (c's average length can be approximated by way of sampling). Similarly, width of an entry in an internal node of a B-Tree can be calculated as W₁=Σ_{cεK} width(c). W_{L} and W_{I} can then be employed to calculate a number of entries per page in leaf (P_{L}) and internal (P_{I}) nodes of the B-Tree. A total number of pages utilized by I can then be calculated as a sum of pages per level in the B-Tree. For a specific example, leaf nodes in the B-Tree fit in S_{O}=┌|T|/P_{L}┐ pages and level i (i≧1) nodes fit in Sᵢ=┌Sᵢ₋₁/P₁┐ pages. Accordingly, size of indexes, such as the index 504, within the configuration 502 can be estimated, and such an estimate 510 can be output by the estimating component 508. It is understood that the above-described method for estimating space consumption of an index and/or a materialized view is but one manner of doing so, and other suitable manners are contemplated and intended to fall under the scope of the hereto-appended claims. Size of materialized views (e.g., the materialized view 506) can be estimated in a similar fashion. For instance, a space consumed by the materialized view 506 (V) can be estimated as a sum of sizes of each index (including a clustered index) defined over V. To approximate |V|, a cardinality module of an optimizer (such as the optimizer of FIGS. 1 and 2) can be utilized to estimate a number of tuples returned by a definition associated with the view 506. Other, more accurate procedures can also be employed.

The estimating component 508 can further be employed to estimate cost associated with index transformations and view transformations. In other words, an estimate can be obtained relating to a performance measure that is affected by an index and/or view transformation. This estimated cost can then be analyzed together with estimated reductions in space of the configuration 502 upon undergoing a transformation, and a transformation can be selected by the search component (FIG. 2) based at least in part upon the analysis. In still more detail, as the configuration 502 is altered, physical structures are removed therefrom. To estimate expense of removing a physical structure, the usage of each physical structure removed can be isolated by the estimating component 508 in order to evaluate sub-expressions using the physical structures in a relaxed or reduced configuration. The estimator 508 can thus output an estimate 510 relating to expected execution costs of removing physical structures from the configuration 502. Further, it can be readily determined that a myriad of means exists for estimating cost, ranging from simple estimators to complex procedures that nearly mimic an optimizer. The estimate(s) 510 can then be employed in connection with heuristics to select transformations to undertake upon the configuration 502.

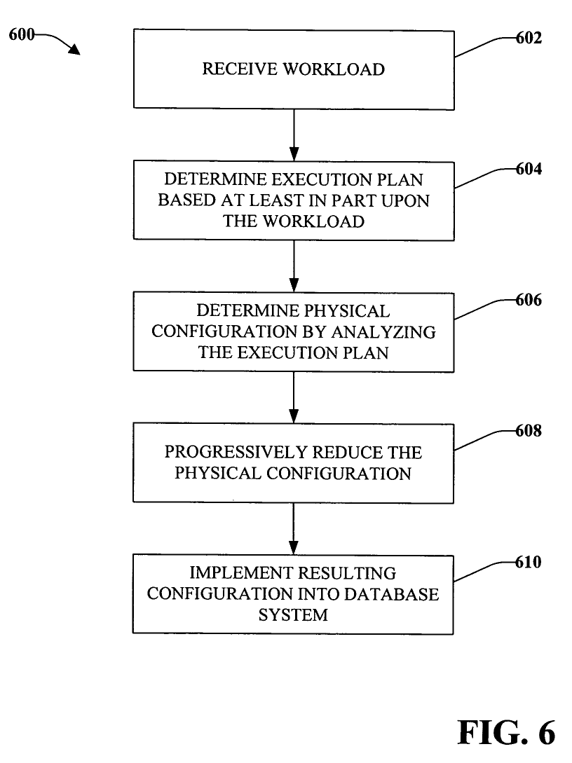

Referring now to FIGS. 6-9, methodologies in accordance with the subject invention will now be described by way of a series of acts. It is to be understood and appreciated that the subject invention is not limited by the order of acts, as some acts may, in accordance with the subject invention, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning solely to FIG. 6, a methodology 600 for automatically tuning physical configuration of a database is illustrated. At 602, a workload is received, wherein the workload can include a plurality of queries and/or updates. The workload is a collection of queries and/or updates that are expected to be utilized in connection with a database system. At 604, a set of hypothetical execution plans is determined based at least in part upon the workload. For instance, an optimizer can determine an optimal hypothetical execution plan for each given query and update within the workload. With reference to FIG. 1, obtaining an optimal configuration was described with respect to a workload that includes only queries (and not updates). Introducing updates into a workload can alter this configuration because indexes needed to be updated, thereby raising cost associated with the workload. A configuration can still be optimal for a select component of each update, and this fact can be employed to obtain/define a lower bound. For instance, updates can be separated into two components: a pure select query, and a small update shell, and execution cost of select queries can be added to execution costs of update shells under a base configuration. Such costs can be accounted for when determining an execution plan.

At 606, a physical configuration is determined by analyzing the execution plans. With more particularity, the physical configuration will include physical structures utilized in the execution plans—thus, the physical configuration can be one that is associated with least possible cost given the workload. At 608, the physical configuration can be progressively reduced in size by way of various relaxation techniques, some of which were described in detail in FIG. 2. Selection of relaxation techniques can be based at least in part upon an estimated penalty associated with each of such techniques with regards to the configuration. Furthermore, greedy algorithms can be employed in connection with relaxing a configuration. At 610, a resulting configuration that meets a threshold size requirement is implemented into a database system.

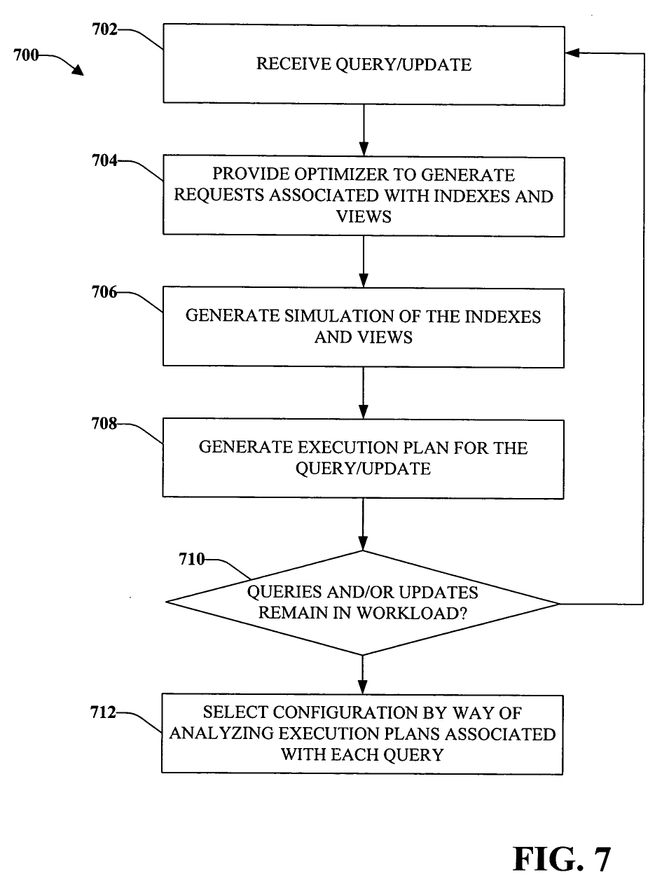

Now referring to FIG. 7, a methodology 700 for generating an optimal configuration given a workload is illustrated. At 702, a sub-query and/or update is received. If an update is received, such update can be separated into a select query and an update shell. For example, the following update query can be received:

UPDATE R SET a=b+1, c=c*c+5 WHERE a<10 AND d<20

This update can be separated into a pure query and an update shell, respectively.

SELECT b+1, c*c+5 FROM R WHERE a<10 AND d<20

UPDATE TOP(k) R SET a=0, c=0

At 704, for each query in the workload, an optimizer that receives the query generates requests relating to indexes and views that would be optimal with respect to such query. At 706, again for each query, a simulation of the indexes and views associated with each request can be generated. Thus, a plurality of indexes and views can result for each query. At 708, an execution plan is generated with respect to the query, wherein the execution plan utilizes the simulated indexes and views generated at 706. Thus, for each query, an optimal execution plan can be created. At 710, a determination is made regarding whether there are any more queries and/or updates remaining within the workload. If there are remaining queries and/or updates, the methodology returns to 702. If there are no remaining queries and/or updates within the workload, a configuration can be selected, wherein the configuration is a union of configurations from each of the execution plans that were generated at 708. In summary, if a workload includes ten queries, ten separate execution plans can be obtained (one for each query). A configuration with respect to the workload can then be obtained as a union of configurations from each execution plan.

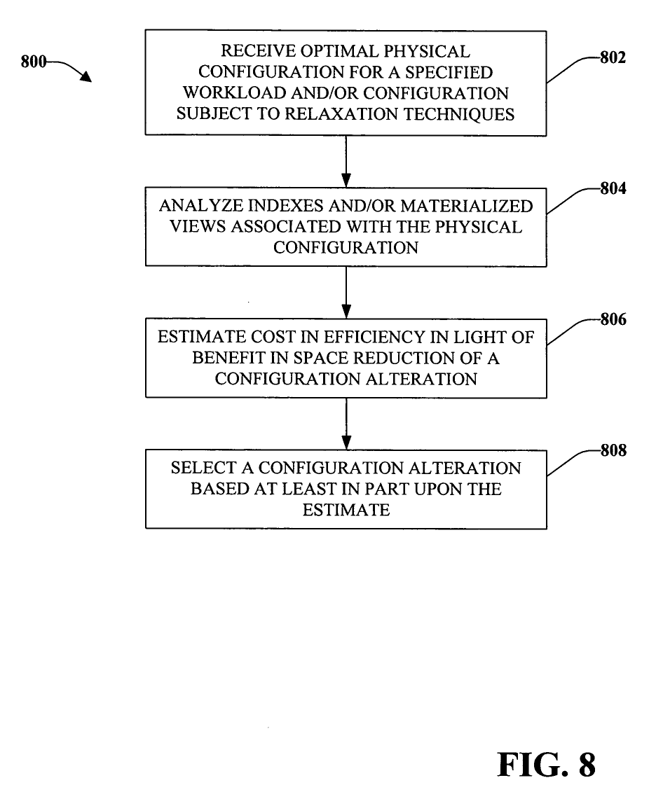

Now turning to FIG. 8, a methodology 800 for estimating cost associated with a relaxation technique (e.g., a merge, split, reduction, . . . ) is illustrated. At 802, an optimal physical configuration for a specified workload and/or a physical configuration that has been previously subject to relaxation techniques (e.g., merging, reduction, . . . ) is received. At 804, indexes and/or materialized views associated with the physical configuration are analyzed, and at 806, a cost in efficiency is estimated in light of a benefit in space reduction with respect to a relaxing technique, such as one of those described with respect to FIG. 2. These estimates can be generated by any suitable means. At 808, a relaxing technique (e.g., index merge, . . . ) is chosen based at least in part upon the estimate.

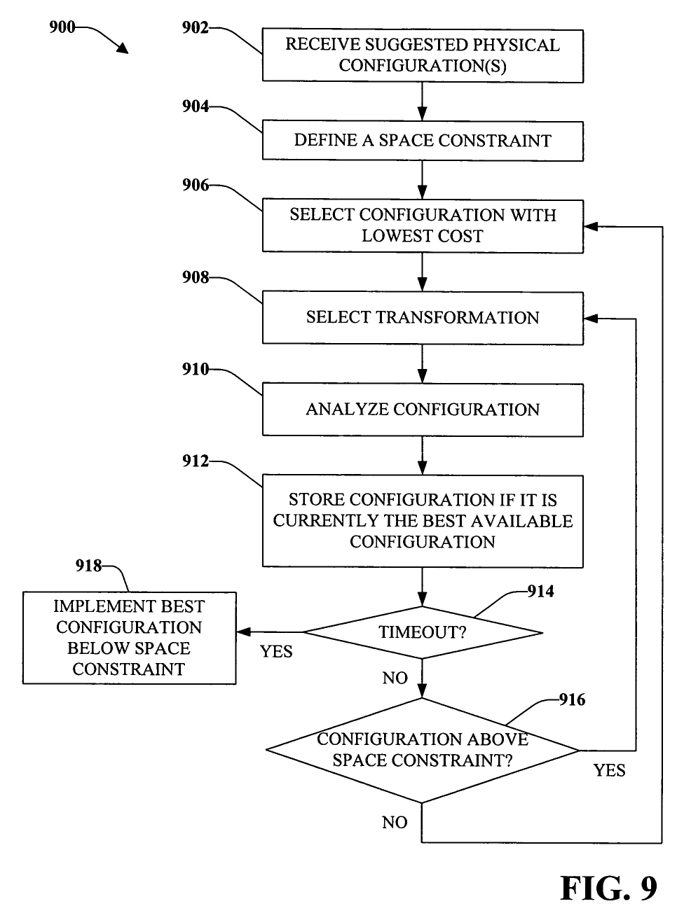

Referring now to FIG. 9, a methodology 900 for selecting a relaxing technique (e.g., a tool to alter a configuration to reduce it in size) is illustrated. At 902, a suggested physical configuration is received, wherein such configuration may be an optimal configuration given a particular workload. At 904, a space constraint is defined. For instance, a database system can be associated with a particular amount of available storage, and thus size of the database system cannot exceed size of available storage. At 906, a configuration with a lowest expected cost (e.g., in terms of time needed to execute a workload) and an available transformation is selected. Initially, such a configuration can be an optimal configuration. At 908, a transformation is selected that results in a lowest cost/space ratio when compared to the ratio of other available transformations (e.g., if there is only one transformation available, such transformation is automatically selected). In more detail, subjecting the configuration to a transformation will affect performance of a database system (e.g., more time is required to execute a workload) while reducing an amount of space required for effectuation of the configuration. Thus, a transformation that reduces a substantial amount of space while not substantially affecting performance is desirable. At 910, the configuration, once it has been subject to a transformation, will be analyzed to determine if it is better than other configurations. If the configuration is currently the best configuration, it is at least temporarily stored at 912. At 914, a determination is made regarding whether a threshold amount of time has passed. If there has not been a timeout, then at 916 a determination is made regarding whether the current configuration is above the space constraint. If there has been a timeout, then at 918 a configuration associated with a highest performance while being below a space constraint is selected and implemented. If, at 916, the configuration is above the space constraint, the methodology 900 can return to 908 (where the configuration can be an initial configuration and/or a configuration that exists after one or more transformations). If the configuration is found to be below the space constraint, then the methodology 900 can return to 910.

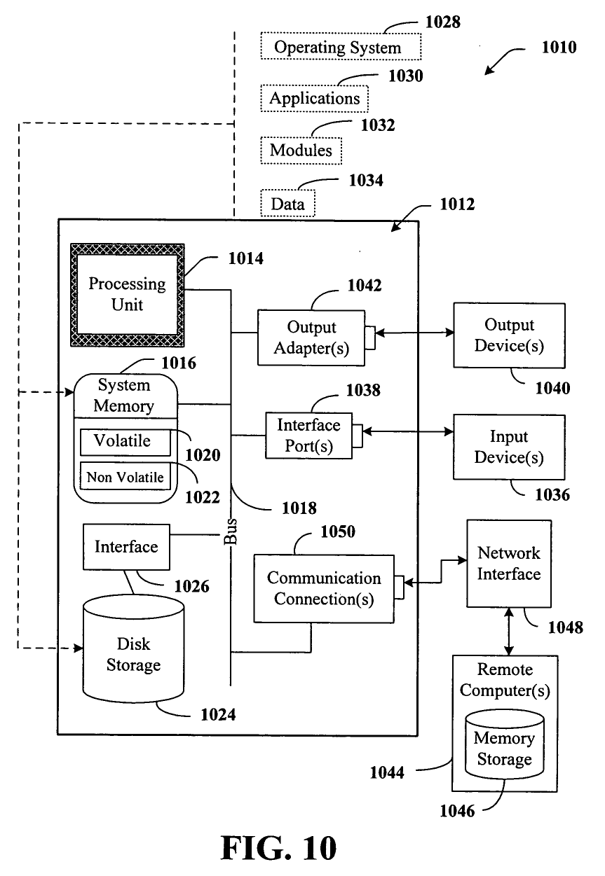

In order to provide additional context for various aspects of the subject invention, FIG. 10 and the following discussion are intended to provide a brief, general description of a suitable operating environment 1010 in which various aspects of the subject invention may be implemented. While the invention is described in the general context of computer-executable instructions, such as program modules, executed by one or more computers or other devices, those skilled in the art will recognize that the invention can also be implemented in combination with other program modules and/or as a combination of hardware and software.

Generally, however, program modules include routines, programs, objects, components, data structures, etc. that perform particular tasks or implement particular data types. The operating environment 1010 is only one example of a suitable operating environment and is not intended to suggest any limitation as to the scope of use or functionality of the invention. Other well known computer systems, environments, and/or configurations that may be suitable for use with the invention include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 10, an exemplary environment 1010 for implementing various aspects of the invention includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI). The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable ROM (EEPROM), or flash memory. Volatile memory 1020 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1012 also includes removable/nonremovable, volatile/nonvolatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in suitable operating environment 1010. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the subject invention can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s)

1036. Thus, for example, a USB port may be used to provide input to computer 1012, and to output information from computer 1012 to an output device 1040. Output adapter 1042 is provided to illustrate that there are some output devices 1040 like monitors, speakers, and printers among other output devices 1040 that require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

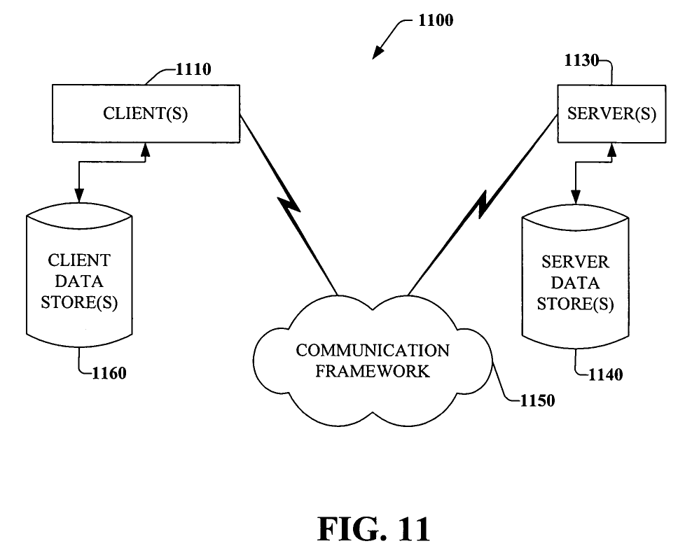

FIG. 11 is a schematic block diagram of a sample-computing environment 1100 with which the subject invention can interact. The system 1100 includes one or more client(s) 1110. The client(s) 1110 can be hardware and/or software (e.g., threads, processes, computing devices). The system 1100 also includes one or more server(s) 1130. The server(s) 1130 can also be hardware and/or software (e.g., threads, processes, computing devices). The servers 1130 can house threads to perform transformations by employing the subject invention, for example. One possible communication between a client 1110 and a server 1130 can be in the form of a data packet adapted to be transmitted between two or more computer processes. The system 1100 includes a communication framework 1150 that can be employed to facilitate communications between the client(s) 1110 and the server(s) 1130. The client(s) 1110 are operably connected to one or more client data store(s) 1160 that can be employed to store information local to the client(s) 1110. Similarly, the server(s) 1130 are operably connected to one or more server data store(s) 1140 that can be employed to store information local to the servers 1130.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates automatic selection of a physical configuration of a database, comprising:
an optimizer component that determines simulated physical structures and creates a hypothetical configuration based thereon; and
a reduction component that progressively reduces size of the hypothetical configuration until the hypothetical configuration is associated with a size below a threshold.

2. The system of claim 1, the hypothetical configuration is an optimal configuration.

3. The system of claim 1, further comprising a simulation component that intercepts requests made by the optimizer component, the simulation component generates the simulated physical structures based at least in part upon the requests.

4. The system of claim 1, the simulated physical structures are based at least in part upon a workload.

5. The system of claim 1, the reduction component replaces at least one physical structure from the hypothetical configuration with zero or more alternatives in connection with progressively reducing size of the hypothetical configuration.

6. The system of claim 5, the replaced physical structure is one of an index and a materialized view.

7. The system of claim 1, further comprising a comparative component that implements the hypothetical configuration if size of the hypothetical configuration is below the threshold.

8. The system of claim 1, the reduction component is associated with a splitting component that rearranges overlapping columns of existing indexes in connection with progressively reducing size of the hypothetical configuration.

9. The system of claim 1, the reduction component is associated with a clustering component that promotes an index to a clustered index in connection with progressively reducing size of the hypothetical configuration.

10. The system of claim 1, the reduction component is associated with a prefixing component that prefixes an index in connection with progressively reducing size of the hypothetical configuration.

11. The system of claim 1, the reduction component is associated with a merging component that merges two indexes in connection with progressively reducing size of the hypothetical configuration.

12. The system of claim 1, further comprising an estimation component that estimates at least one of an amount of space consumed by an index and an amount of space consumed by a materialized view.

13. The system of claim 1, further comprising an estimation component that estimates an expected execution cost for a workload with respect to the hypothetical configuration if a given transformation were to take place.

14. The system of claim 1, further comprising a search component that searches for a relaxation technique to apply to the hypothetical configuration, the search completed within a threshold time.

15. A method for automatically tuning a database, comprising:
generating a configuration based upon a received workload; and
selectively relaxing the configuration until size of the configuration is below a threshold size.

16. The method of claim 15, the configuration is an optimal configuration with respect to the received workload.

17. The method of claim 15, further comprising analyzing one or more of an index and a materialized view in connection with selectively relaxing the configuration.

18. The method of claim 15, further comprising estimating a cost of relaxing the configuration and an amount of space by which the configuration is reduced and selectively relaxing the configuration based thereon.

19. The method of claim 15, further comprising selecting a relaxed configuration to implement within a database system within a threshold time.

20. A computer-implemented database tuning system, comprising:
means for generating an optimal configuration with respect to a workload; and
means for relaxing the configuration to cause a resulting configuration to be within a space constraint.
